(19) United States
(12) Patent Application Publication
(10) Pub. No.: US 2011/0049052 A1
(43) Pub. Date: Mar. 3, 2011

(54) METHOD FOR INHIBITING THE DEPOSITION OF SILICA AND/OR SILICATE COMPOUNDS IN AQUEOUS SYSTEMS

(76) Inventors: Keith A. Hirsch, Canton, MI (US); Chacko Thankachan, West Bloomfield, MI (US)

(21) Appl. No.: 12/552,964

(22) Filed: Sep. 2, 2009

(51) Int. Cl. C02F 1/68; B01D 61/02

(52) U.S. Cl. 210/652; 210/698

(57) ABSTRACT

A method inhibits the deposition of silica and/or silicate compounds on a surface in an aqueous system. The method includes the step of adding a polymer to the aqueous system. The polymer comprises the reaction product of a natural oil component and an alkylene oxide. The polymer of the subject invention has a core, comprising a fatty acid or an ester thereof, and a plurality of polymeric side chains bonded to the core. The plurality of polymeric side chains comprise alkyleneoxy groups selected from the group of ethyleneoxy groups, propyleneoxy groups, butyleneoxy groups, and combinations thereof.

### BACKGROUND OF THE INVENTION

1. Field of the Invention

The subject invention generally relates to a method of inhibiting the deposition of silica and/or silicate compounds on a surface in an aqueous system. More specifically, the subject invention relates to a method of inhibiting the deposition of silica and/or silicate compounds on a surface in an aqueous system by adding a polymer comprising a natural oil alkoxylate to the aqueous system.

2. Description of the Related Art

Formation, precipitation and deposition of scale is problematic in an aqueous system such as a steam generating system, a cooling water system, a membrane separation system, and the like. A number of approaches have been developed in an effort to prevent the deposition of scale in the aqueous system.

The formation of scale in the aqueous system originates from several causes. Typically, sulfates, silica, silicates, high concentrations of phosphate, as well as carbonates of calcium and magnesium, either occurring naturally or added to the water of the aqueous system for other purposes, react to form the scale. The scale comprises calcium, magnesium, silica and/or silicate compounds, and other compounds.

One particular type of scale, silica scale, comprises the silica and/or silicate compounds. Silica and/or silicates are naturally present in water. When the water is cycled in the aqueous system, a concentration of silica and/or silicates increases to the point at which the precipitation of silica scale from the water of the aqueous system occurs. Sometimes the precipitation of silica scale proceeds by a polymerization of the silica itself, resulting in a silica gel (i.e. a silicate compound). Typically, for the precipitation of silica scale to occur, the concentration of silica and/or silicate in the water of the aqueous system must be greater than 200 ppm. However, changes in a pH of the water affect the precipitation of silica scale. Moreover, when cations are present in the water of the aqueous system, the precipitation of silica scale can occur when the silica and/or silicate concentration is less than 200 ppm. Cations that promote the silica scale precipitation include, but are not limited to, Al²⁺, Mg²⁺, Zn²⁺, and Fe³⁺.

The formation and the precipitation of silica scale is followed by the deposition of silica scale on a surface of an internal component, such as a pipe, a membrane, a packing material, and a like component of the aqueous system. Typically, the deposition of silica scale occurs on the surface of the internal component resulting in a hard incrustation of silica scale. The deposition of silica scale on the internal component restricts circulation of the water of the aqueous system. In some cases, the aqueous system requires heating and/or cooling of the water for various purposes, the silica scale deposition on the internal component impedes heat transfer functions of the aqueous system. In other cases, the deposition of silica scale on the internal component results in inadequate water quality. As such, the deposition of silica scale reduces operational efficiency of the aqueous system.

Once the silica scale is deposited on the internal component of the aqueous system, the way to remove the silica scale is with an acid wash. In many cases, the deposition of silica scale necessitates replacement of the internal component of the aqueous system.

One approach to preventing the deposition of silica scale in the aqueous system makes use of an external treatment of the water. Typically, the external treatment includes methods such as, coagulation, filtration, and softening of the water prior to use in the aqueous system. Use of the external treatment is only moderately effective in preventing the formation, the precipitation, and the deposition of silica scale in the aqueous system. In all cases, the external treatment does not prevent the formation, the precipitation and the deposition of silica scale since, mud, sludge and hardness-imparting ions escape the external treatment, and are introduced into the aqueous system.

Another approach to preventing the deposition of silica scale in the aqueous system makes use of an internal treatment of the water. Typically, the internal treatment includes adding a silica scale inhibitor to the water of the aqueous system. The addition of the silica scale inhibitor keeps the silica and/or silicates dissolved in the water of the aqueous system.

Various monomers, oligomers and polymers have been added to the aqueous system as the silica scale inhibitor. Generally, these monomers, oligomers and polymers are formed from feedstock produced with a non-renewable resource such as petroleum oil, which is undesirable. Initially, monomeric and/or oligomeric silica scale inhibitors, often comprising an amine and one or more straight-chain fatty acids, were added to the aqueous system. Eventually, polymeric silica scale inhibitors, such as polymers comprising the reaction product of ethylene oxide and propylene oxide, were introduced. Recently, complex, polymeric silica scale inhibitors, such as polymers having a polyether backbone with regularly or randomly spaced hydrophobic groups along the polyether backbone and polycarboxylate polymers were introduced. The complex, polymeric silica scale inhibitors typically comprise a reaction product of multiple compounds and having a specific chemical structure.

Despite the improvement of the silica scale inhibitor in the marketplace, there remains a need to further improve the silica scale inhibitor. In view the foregoing, it would be advantageous to provide an improved method for inhibiting the formation and deposition of silica scale in the aqueous system with a silica scale inhibitor comprising a polymer that addresses the needs set forth above.

### SUMMARY OF THE INVENTION AND ADVANTAGES

The subject invention provides a method of inhibiting the deposition of silica and/or silicate compounds on a surface in an aqueous system. The method includes the step of adding a polymer to the aqueous system. The polymer comprises the reaction product of a natural oil component and an alkylene oxide.

The polymer of the subject invention may be formed with basic chemical processes requiring few resources. Advantageously, the polymer of the subject invention further improves upon performance of existing silica and/or silicate compound inhibitors. The excellent silica and/or silicate compound inhibition properties of the subject invention are, in part, a result of a structure of the polymer. The structure of the polymer is attributable to the natural oil component.

The natural oil component of the polymer is also advantageous from an environmental perspective. The natural oil component is a feedstock from a renewable resource. In turn, potential environmental concerns associated with the use of silica and/or silicate compound inhibitors in aqueous systems and the subsequent disposal of water from such aqueous systems may be alleviated with the polymer of the subject invention.

### BRIEF DESCRIPTION OF THE DRAWING

Other advantages of the present invention will be readily appreciated, as the same becomes better understood by reference to the following detailed description when considered in connection with the accompanying drawing wherein:

FIG. 1 is a graph depicting the inhibition performance of Examples 1-5.

### DETAILED DESCRIPTION OF THE INVENTION

A method according to this invention inhibits a deposition of silica and/or silicate compounds on a surface in an aqueous system. The deposition of silica and/or silicate compounds on the surface occurs frequently in aqueous systems. The deposition of silica and/or silicate compounds on the surface in the aqueous system is commonly referred to as scale or silica scale. The aqueous system includes an aqueous component and the surface. The aqueous component typically comprises water and materials, which are dissolved and/or suspended in the water, such as, silt, clay, organic wastes, inorganic salts, silica and/or silicate compounds.

The surface on which deposition of silica and/or silicate compounds is inhibited is further defined as any surface that is in contact with the aqueous component. For example, the aqueous system may include any apparatus having the surface in contact with the aqueous component of the aqueous system. The apparatus may be any device including, but not limited to, cooling water apparatuses, boiler water apparatuses, steam generating apparatuses, desalinization apparatuses, gas scrubber apparatuses, evaporator apparatuses, paper manufacturing apparatuses, mining apparatuses, and separation or filtration apparatuses having a membrane such as reverse osmosis apparatuses, ultrafiltration apparatuses, and nanofiltration apparatuses. The surface may be any component of the apparatus on which the silica and/or silicate compounds may deposit and may include, but is not limited to, pipes, collection devices, agitating devices, filters, membranes, and packing materials. The surface may include any kind of material such as, but not limited to, iron, steel, copper, ceramic, plastic, glass, and materials conventionally used to form membranes.

The method of inhibiting the deposition of silica and/or silicate compounds on the surface in the aqueous system comprises the step of adding a polymer to the aqueous system. For example, the polymer can be added to the aqueous system such as a cooling tower or a heat exchanger having a closed circulation loop. The polymer comprises a reaction product of a natural oil component and an alkylene oxide.

The natural oil component is defined as a non-petroleum oil. Generally, the natural oil component includes at least one natural oil and/or a reaction product of at least one natural oil and a compound reactive with the natural oil. The natural oil component is a feedstock formed from the renewable resource such as soy oil and/or other renewable resources that can be generated by means such as harvesting plant crops. Use of feedstocks formed from renewable resources reduces environmental impact by decreasing demand on petroleum oils and other non-renewable resources. The natural oil component is typically hydroxyl functional. Hydroxyl functionality provides one or more reaction sites on the natural oil component at which polymeric side chains can bond. The natural oil component influences structure and the inhibition performance of the polymer. Generally, the natural oil component is hydrophobic and insoluble in water.

Typically, the natural oil component comprises a natural oil. One particularly suitable natural oil is castor oil. Castor oil comprises triglycerides. A triglyceride is a glyceride in which glycerol is esterified with three fatty acids, i.e., castor oil comprises triglycerides, which comprise fatty acids. Approximately ninety percent of these fatty acids comprise ricinoleic acid, the other, approximately ten percent of these fatty acids comprise oleic acid, linoleic acid, stearic acid, palmitic acid, and/or dihydroxystearic acid. As is well known in the art, castor oil is produced directly from castor seeds and is hydroxyl functional.

Other natural oils, which do not have hydroxyl groups, and which have carbon-carbon double bonds, typically require a chemical modification to introduce an active hydrogen-containing functional group. An example is oxidation of carbon-carbon double bonds to functionalize the natural oil with the active hydrogen-containing functional group for future alkoxylation. Any chemical modification known to those skilled in the art may be used to functionalize the natural oil with the active hydrogen-containing functional group. Active hydrogen-containing functional groups, suitable for the present invention, include, but are not limited to, amino groups, hydroxyl groups, carboxyl groups, and combinations thereof. Active hydrogen-containing functional groups provide one or more reaction sites on the natural oil at which polymeric side chains can bond, for example, via the alkoxylation noted above. Other natural oils, suitable for the present invention, include, but are not limited to, canola oil, coconut oil, corn oil, palm oil, peanut oil, soy oil, tall oil, and combinations thereof.

The natural oil component may comprise at least one of monoglyceride, diglyceride, and triglyceride. The natural oil component may include a mixture of differing monoglycerides, diglycerides, and triglycerides. A particularly suitable natural oil component comprises a triglyceride. The chemical formula of the triglyceride is RCOO—CH₂CH(—OOCR′)CH₂—OOCR″, where R, R′, and R″ are alkyl chains. The three fatty acids, RCOOH, R′COOH and R″COOH can be all different, all the same, or only two the same. Chain lengths of fatty acids in naturally occurring triglycerides can be of varying length, but 16, 18 and 20 carbon molecules are common.

The natural oil component may comprise a fatty acid. The fatty acid is typically a carboxylic acid (mono and/or dibasic) having from 7 to 100 carbon atoms, more typically from 10 to 25 carbon atoms, and most typically from 14 to 22 carbon atoms. The fatty acid can be saturated or unsaturated, aliphatic or cycloaliphatic, and/or unsubstituted or substituted with other functional groups such as hydroxyl groups. Suitable fatty acids include, but are not limited to, cetyl acid, lauric acid, linoleic acid, myristoleic acid, oleic acid, palmitic acid, palmotoeic acid, ricinoleic acid, and stearic acid. Mixtures of two or more of the above described fatty acids may be present in the natural oil component. A particularly suitable fatty acid for the present invention is ricinoleic acid.

As mentioned previously, the polymer is the reaction product of the natural oil component and the alkylene oxide. Because the feedstock is formed from a renewable resource, variations in composition of the natural oil component are common. Without being bound by theory, it is believed that variations in the natural oil component result in variations in the polymer and structure of the polymer, and those variations in the polymer and structure of the polymer are beneficial to the inhibition performance of the polymer.

Preferably, the alkylene oxide that reacts with the natural oil component to form the polymer is selected from the group of ethylene oxide, propylene oxide, butylene oxide, and combinations thereof. Other alkylene oxides including, but not limited to, tetrahydrofuran, epihalohydrins, aralkylene oxides, and combinations thereof may be suitable as well. Of course, the invention is not limited to any one of the aforementioned alkylene oxides and any combination of alkylene oxides can be used. However, it is also contemplated that any suitable alkylene oxide that is known in the art may be used in the present invention.

The polymer of the present invention is formed via alkoxylation. Alkoxylation is a chemical reaction in which the alkylene oxide, such as ethylene oxide and/or propylene oxide, is added to the natural oil component, such as castor oil. The alkoxylation is completed by preheating the natural oil component and reacting it with the alkylene oxide in the presence of a catalyst, such as potassium hydroxide (KOH). Typically, the alkoxylation takes place in a chemical reactor, which is heated and pressurized with nitrogen. However, it is to be appreciated that formation of the polymer of the instant invention is not limited to any particular chemical reaction.

Typically, the polymer formed via alkoxylation includes a core, comprising a fatty acid or an ester thereof, and a plurality of polymeric side chains comprising alkyleneoxy groups bonded to the core. The term alkyleneoxy group describes a mer, or unit, of the polymeric side chains. The alkyleneoxy group is the unit which results from the reaction of the alkylene oxide. The plurality of polymeric side chains preferably comprise the alkyleneoxy groups selected from the group of ethyleneoxy groups, propyleneoxy groups, butyleneoxy groups, and combinations thereof. The plurality of polymeric side chains of the polymer are terminated with a hydrogen atom. The polymer, which is water soluble, comprises the core, which was once the hydrophobic, and also comprises the plurality of polymeric side chains, which are hydrophilic.

The plurality of polymeric side chains of the polymer are independently selected from the group of polymers having random groups, polymers having repeating groups, and polymers having block groups. The plurality of polymeric side chains of the polymer may be branched or linear. Furthermore, the plurality of polymeric side chains may be cross-linked with each other. A particularly suitable polymer has a plurality of side chains, which are linear, and comprise ethyleneoxy groups and propyleneoxy groups arranged randomly. Typically, alkoxylation of the natural oil component with propylene oxide and ethylene oxide allows for formation of the polymer having the plurality of polymeric side chains having a molecular weight which is greater than a molecular weight of the plurality of polymeric side chains formed with the ethylene oxide alone. Said differently alkoxylation of the natural oil component with both ethylene oxide and propylene oxide forms longer side chains than does alkoxylation of the natural oil component with just ethylene oxide. Without being bound to any particular theory, it is believed that the plurality of polymeric side chains enable the polymer to wrap around molecules and/or small particles of the silica and/or silica compounds that are dissolved and/or suspended in the aqueous component of the aqueous system and that would otherwise be prone to precipitation, with the polymer thereby inhibiting precipitation of the silica and/or silica compounds.

It is also believed that molecular weight of the polymer impacts silica and/or silicate compound inhibition properties of the polymer. The polymer of the present invention typically has molecular weight of from about 300 to about 15,500, more typically of from about 400 to about 12,500, and most typically of from about 500 to about 9,500.

In a particularly preferred embodiment the polymer comprises a reaction product of castor oil and the alkylene oxide. The alkylene oxide of this embodiment includes a first alkylene oxide which is ethylene oxide and a second alkylene oxide which is propylene oxide. The ethylene oxide is typically present in the polymer in an amount of from about 22 to about 92, more typically in an amount of from about 42 to about 72, and most typically in an amount of from about 52 to about 62 percent by weight, based on 100 parts by weight of the alkylene oxide. The propylene oxide is typically present in the polymer in an amount of from about 8 to about 78, more typically in an amount of from about 28 to about 58, and most typically in an amount of from about 38 to about 48 percent by weight, based on 100 parts by weight of the alkylene oxide. In this embodiment, the core is branched and the plurality of polymeric side chains are linear and comprise ethyleneoxy groups and propyleneoxy groups arranged randomly. In the aforementioned embodiment, the ethyleneoxy groups and the propyleneoxy groups are present in the polymer in a molar ratio of ethyleneoxy groups to propyleneoxy groups from about 4:1 to about 1:4, more typically of from about 2.5:1 to about 1:2, and most typically of about 2:1 to about 1:1. In this embodiment, the polymer typically has a molecular weight of from about 500 to about 15,000, more typically of from about 3,000 to about 10,500, and most typically of from about 4,000 to about 9,500. One such polymer is POLYTERGENT® 777 sold under the trademark POLYTERGENT® and commercially available from BASF Corporation. For purposes of the present invention, other castor oil based polymers may be suitable as well.

In another embodiment the polymer comprises a reaction product of the natural oil component, derived from palm oil, and the ethylene oxide. The natural oil component of this embodiment comprises monoglycerides and diglycerides of palm stearine. In this embodiment, the core is branched and the plurality of polymeric side chains are linear and comprise ethyleneoxy groups. Also, in this embodiment, the polymer typically has a molecular weight of from about 250 to about 15,000, more typically of from about 500 to about 10,000, and most typically of from about 750 to about 1,500. One such polymer is MAZOL® 80 MGK sold under the trademark MAZOL® and commercially available from BASF Corporation.

In another embodiment the polymer comprises a reaction product of the natural oil component, derived from coconut oil, and the ethylene oxide. The natural oil component of this embodiment comprises cetosteryl alcohol. In this embodiment, the core is linear and the polymeric side chain is linear and comprises ethyleneoxy groups. Also, in this embodiment, the polymer typically has a molecular weight of from about 500 to about 15,000, more typically of from about 700 to about 10,000, and most typically of from about 900 to about 1,250. One such polymer is MACOL® CSA 20 sold under the trademark MACOL® and commercially available from BASF Corporation.

In yet another embodiment the polymer comprises a reaction product of castor oil and the ethylene oxide. In this embodiment, the core is branched and the plurality of polymeric side chains are linear and comprise ethyleneoxy groups. The polymer of this embodiment typically has a molecular weight of from about 500 to about 15,000, more typically of from about 1,000 to about 10,000, and most typically of from about 1,500 to about 3,000. One such polymer is EMULAN® EL sold under the trademark EMULAN® and commercially available from BASF Corporation.

In yet another embodiment the polymer comprises a reaction product of a natural oil component and the ethylene oxide. The natural oil component of this embodiment comprises sorbitan monooleate. In this embodiment, the core is branched and the plurality of polymeric side chains are linear and comprise ethyleneoxy groups. The polymer of this embodiment typically has a molecular weight of from about 250 to about 15,000, more typically of from about 500 to about 10,000, and most typically of from about 750 to about 1,500. One such polymer is T-MAZ® 80 sold under the trademark T-MAZ® and commercially available from BASF Corporation.

The embodiments of the present invention described above have been presented for the purposes of illustration and description. The embodiments are not intended to be exhaustive or limit the present invention. The embodiments were chosen and described in order to best explain the principle of the invention and its practical applications to enable others skilled in the art to best utilize the invention in its various embodiments and with various modifications as suited to the particular use contemplated.

Of course, the polymer of the subject invention may include a combination of one or more polymers. For example, the polymer may be used alone or in combination with other water treating agents. The polymer may be used in combination with phosphoric acids and their salts, metal chelating agents, corrosion inhibitors, polymer scale control dispersants, microbiocides, flocculants, coagulants, oxygen scavengers, neutralizing amines, scale inhibitors, acrylic acid polymers and copolymers, maleic acid and maleic anhydride polymers and copolymers, and other water treating agents.

As mentioned previously, the method comprises the step of adding the polymer to the aqueous system. The polymer is added to the aqueous component in an amount of from about 0.5 to about 500, more typically in an amount of from about 0.8 to about 350, and most typically in an amount of from about 1 to about 100 ppm of the aqueous component. The polymer may be added to the aqueous component directly, as described above. Alternatively, the polymer may be first mixed with a fluidic carrier to form a solution and the solution may be added to the aqueous component.

Without being limited to any particular theory, it is believed that when finite or set amounts of the polymer are present in the aqueous component along with the dissolved silica and/or silicates, the polymer binds up the dissolved silica and/or silicates. When excessive amounts of dissolved silica and/or silicates are present in the aqueous component, the polymer may be overwhelmed to a point where the polymer is completely or substantially bound with silica and/or silicates, i.e., “used up”. At this point, any remaining dissolved silica and/or silicates are free to react with cations or like dissolved silica and/or silicates, thus eventually leading to precipitation and deposition of silica and/or silicate compounds.

The following examples are intended to illustrate the present invention and are not to be viewed in any way as limiting to the scope of the present invention.

### EXAMPLES

Various polymers are formed. Examples 1-5 are polymers according to the present invention. The polymer of the present invention comprises a reaction product of a natural oil component and an alkylene oxide. A general description of the natural oil component and the alkylene oxide of Examples 1-5 are provided in Table 1 below.

TABLE 1

| | Example No. | | | | |
|---|---|---|---|---|---|
| | Example 1 | Example 2 | Example 3 | Example 4 | Example 5 |
| Natural Oil | Castor Oil | Monoglycerides | Cetosteryl | Castor Oil | Sorbitan |
| Component | | and | Alcohol | | Monooleate |
| | | Diglycerides of | | | |
| | | Palm Stearine | | | |
| Alklyene | Ethylene Oxide, | Ethylene Oxide | Ethylene | Ethylene | Ethylene |
| Oxide | Propylene Oxide | | Oxide | Oxide | Oxide |

Comparative Examples 1-10 are commercially available polymers, not according to the present invention, and formed from non-renewable (i.e, petroleum-based) resources. Comparative Examples 1-10 are included to provide a basis for comparison for the unexpected and advantageous effects of the polymers of Examples 1-5.

Example 1 is a heteric alkoxylate of castor oil and ethylene oxide and propylene oxide.

Example 2 is a 20-mole ethoxylate of palm stearine monoglycerides and palm stearine diglycerides.

Example 3 is a 20-mole ethoxylate of cetostearyl alcohol.

Example 4 is a 33-mole ethoxylate of castor oil.

Example 5 is a 20-mole ethoxylate of sorbitan monooleate.

Comparative Example 1 is VERSAFLEX® Si, a silica scale inhibitor sold under the trademark VERSAFLEX® and commercially available from Akzo Nobel.

Comparative Example 2 is ACUMER® 5000, a silica scale inhibitor sold under the trademark ACUMER® and commercially available from Dow Chemical Company.

Comparative Example 3 is CARBOSPERSE® KXP-212, a silica scale inhibitor sold under the trademark CARBOSPERSE® and commercially available from Lubrizol Corporation.

Comparative Example 4 is a terpolymer of acrylic acid, methacrylic acid, and a taurine-acrylic monomer.

Comparative Example 5 is copolymer of acrylic acid/maleic acid in a sodium salt form having a number average molecular weight of about 50,000 g/mol.

Comparative Example 6 is polyacrylic acid with a number average molecular weight of about 4,000 g/mol.

Comparative Example 7 is modified polyacrylic acid having a number average molecular weight of about 3,000 g/mol.

Comparative Example 8 is modified polyacrylic acid having a number average molecular weight of about 20,000 g/mol.

Comparative Example 9 is a terpolymer of acrylic acid, methacyrlic acid, and a methyl polyethylene glycol ester of methacrylic acid having a number molecular weight of about 13,000 g/mol.

Comparative Example 10 is a copolymer of maleic acid and isobutene having a number molecular weight of about 4,000 g/mol.

The polymers of Examples 1-5 and the polymers of Comparative Examples 1-10 are evaluated to determine performance properties including inhibition of precipitation of silica and/or silicate compounds from an aqueous component that includes water, dissolved silica (sodium silicate), calcium ions (Ca²⁺), magnesium ions (Mg²⁺), and chloride ions (Cl⁻) at a pH of 7.0 and at 40° C. To perform the test, three aqueous stock solutions are prepared: a 0.2 M Na₂SiO₃ solution, a 0.2 M CaCl₂ and 0.2 M MgCl₂ solution, and a polymer solution comprising about 1,000 ppm of the polymer in water.

A 200.0 mL test aqueous component is prepared containing 5.0 mL of the polymer solution, 8.6 mL of the 0.2 M Na₂SiO₃ solution, and 5.0 mL of the 0.2 M CaCl₂/0.2 M MgCl₂ solution, with the volume adjusted to 200.0 mL with distilled water. The test aqueous component is adjusted to a pH of 7.0 which is maintained throughout the test. The test aqueous component contains the following concentrations: 450-640 ppm of dissolved silica present as SiO₂, 200 ppm of Ca²⁺, 120 ppm of Mg²⁺, and 25 ppm of the polymer. The test aqueous component is placed in a beaker containing a 2-hole rubber stopper. One hole is used for a pH probe and the second hole for sampling. The test aqueous component is stirred while heating at 40° C. in a circulating bath. A 3.0 to 5.0 mL sample is periodically removed and passed through a 0.22 μm filter. A 2.0 mL sample of the filtrate is taken and diluted to 25.0 mL with distilled water. The contents of one molybdate reagent pillow for high-range silica (available from Hach Co., Loveland, Colo.) are added to 10 mL of the sample and the sample is shaken to dissolve the contents of the molybdate reagent pillow. The contents of one acid reagent pillow (also available from Hach Co., Loveland, Colo.) are added to the sample and the sample is shaken to dissolve the contents of the acid reagent pillow. After allowing the sample to sit for 10 minutes, the contents of one citric acid pillow (also available from Hach Co., Loveland, Colo.) are added to the sample and the sample is shaken gently to avoid bubble formation and to dissolve the contents of the citric acid pillow. The sample is then allowed to stand for two minutes. The molybdate reagent reacts with any silicic acid/silicate and quantitatively forms a yellow compound. Color intensity of the yellow compound is proportional to an amount of dissolved silica and/or silicates present in the test aqueous component. Color intensity is determined by measuring absorbance of the yellow compound with a spectrophotometer at 450 nm.

Absorbance is obtained for the test aqueous component immediately following its preparation and 22 hours after preparation. The amount of dissolved silica and/or silicates present 22 hours after preparation represents a stabilized silica concentration. Generally, higher stabilized silica concentrations are an indicator of higher effectiveness of the polymer as an inhibitor of deposition of silica and/or silicate compounds.

Since the concentration of the polymers utilized throughout the inhibition test remains constant, regardless of the concentration of the dissolved silica and/or silicates, the amount of dissolved silica and/or silicates present 22 hours after preparation accurately indicates the effectiveness of the polymer as an inhibitor of deposition of silica and/or silicate compounds.

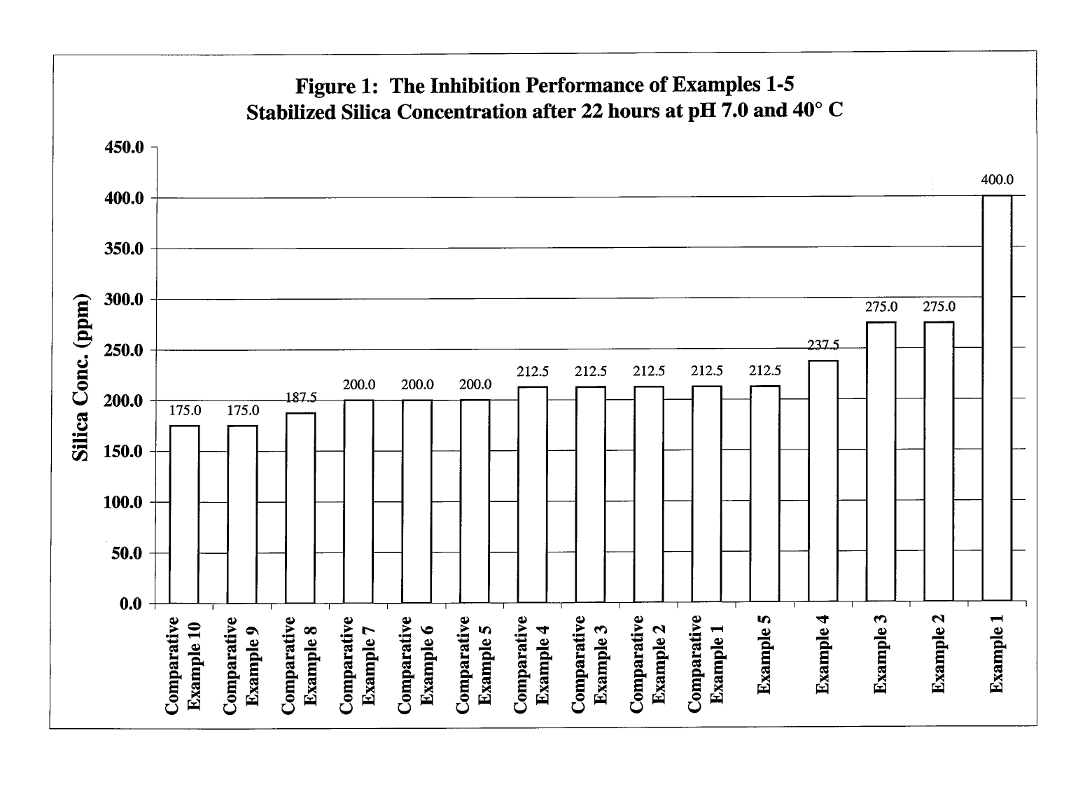

Examples 1-5 and Comparative Examples 1-10 are evaluated to determine an inhibition performance after 22 hours utilizing the test described above. The results of the evaluations are shown in Table 2 below and depicted graphically in FIG. 1.

TABLE 2

| Silica and/or Silicate Compound | Stabilized Silica |
|---|---|
| Inhibitor | Concentration (ppm) (22 hours) |
| Example 1 | 400 |
| Example 2 | 275 |
| Example 3 | 275 |
| Example 4 | 237.5 |
| Example 5 | 212.5 |
| Comparative Example 1 | 212.5 |
| Comparative Example 2 | 212.5 |
| Comparative Example 3 | 212.5 |
| Comparative Example 4 | 212.5 |
| Comparative Example 5 | 200 |
| Comparative Example 6 | 200 |
| Comparative Example 7 | 200 |
| Comparative Example 8 | 187.5 |
| Comparative Example 9 | 175 |
| Comparative Example 10 | 175 |

As can be seen from the data presented in Table 2, the polymers of Examples 1-5 provide excellent inhibition performance in contrast to the polymers of Comparative Examples 1-10. The polymer of Example 1, which is a reaction product of castor oil, ethylene oxide, and propylene oxide, outperforms the polymers of all other Examples and Comparative Examples tested, having a stabilized silica concentration of 400 ppm. The polymer of Example 1 has a plurality of polymeric side chains, which are linear and comprise a random arrangement of ethyleneoxy groups and propyleneoxy groups. The excellent inhibition performance of the polymer of Example 1 is a result of the structure of the polymer.

The polymer of Example 2 demonstrates excellent inhibition performance as well, having a stabilized silica concentration of 275. Aside from the polymers of Examples 1 and 2 having excellent inhibition performance, they both have polymeric side chains that are linear.

The polymer of Example 3 demonstrates the same inhibition performance as the polymer of Example 2. The polymer of Example 3 is formed from cetostryl alcohol and has a plurality of polymeric side chains that are linear and comprise ethyleneoxy groups.

The polymer of Example 4, which is a reaction product of castor oil and ethylene oxide, has a stabilized silica concentration of 237.5 ppm. Like the polymer of Example 1, the polymer of Example 4 is formed from castor oil. However, the polymer of Example 4 has a plurality of polymeric side chains that are linear and have ethyleneoxy groups. Also, the polymer of Example 4 also has a lower average molecular weight than the polymer of Example 1. A difference in inhibition performance between the polymer of Example 4 and the polymer of Example 1 is believed to be attributable to differences in the plurality of polymeric side chains.

The polymer of Example 5 performs as well as or better than all of the polymers of the Comparative Examples. The polymer of Example 5 comprises a polymer formed from the natural oil component, which is formed from tall oil, and has a branched core and a plurality of polymeric side chains that are linear and comprise ethyleneoxy groups.

The polymers of Examples 1-5, according to the present invention, exhibit inhibition performance equal to or better than the inhibition performance of the polymers Comparative Examples 1-10. As a silica and/or silicate compound inhibitor, the polymer of Example 1 outperforms the polymers of all other Examples and Comparative Examples. The inhibition performance of Examples 1-5 is thought to result, in part, from the polymers and the structures of Examples 1-5. The Examples demonstrate the use of the polymers that (a) are the reaction product of a natural oil component and an alkylene oxide and (b) demonstrate excellent inhibition performance.

The present invention has been described in an illustrative manner, and it is to be understood that the terminology which has been used is intended to be in the nature of words of description rather than of limitation. Obviously, many modifications and variations of the present invention are possible in light of the above teachings. It is, therefore, to be understood that within the scope of the appended claims, the present invention may be practiced otherwise than as specifically described.

What is claimed is:

1. A method of inhibiting the deposition of silica and/or silicate compounds on a surface in an aqueous system, said method comprising the steps of:
providing water in the aqueous system;
circulating the water in the aqueous system; and
introducing a polymer to the water, the polymer comprising the reaction product of a natural oil component and an alkylene oxide.

2. A method as set forth in claim 1 wherein the aqueous system includes a reverse osmosis apparatus.

3. A method of inhibiting the deposition of silica and/or silicate compounds on a surface in an aqueous system, said method comprising the step of adding a polymer to the aqueous system, the polymer comprising the reaction product of a natural oil component and an alkylene oxide.

4. A method as set forth in claim 3 wherein the natural oil component is further defined as a non-petroleum oil.

5. A method as set forth in claim 3 wherein the natural oil component comprises a fatty acid or an ester thereof.

6. A method as set forth in claim 3 wherein the natural oil component comprises at least one of monoglyceride, diglyceride, and triglyceride.

7. A method as set forth in claim 3 wherein the natural oil component comprises castor oil.

8. A method as set forth in claim 3 wherein the natural oil component comprises a natural oil.

9. A method as set forth in claim 8 wherein the natural oil comprises at least one of monoglyceride, diglyceride, and triglyceride.

10. A method as set forth in claim 8 wherein the natural oil is selected from the group of canola oil, castor oil, coconut oil, corn oil, palm oil, peanut oil, soy oil, tall oil and combinations thereof.

11. A method as set forth in claim 8 wherein the natural oil is castor oil.

12. A method as set forth in claim 3 wherein the natural oil component comprises a reaction product of a natural oil and a compound reactive with the natural oil, with the reaction product having one or more active hydrogen-containing functional groups.

13. A method as set forth in claim 3 wherein the alkylene oxide is selected from the group of ethylene oxide, propylene oxide, butylene oxide, and combinations thereof.

14. A method as set forth in claim 3 wherein the alkylene oxide is ethylene oxide.

15. A method as set forth in claim 3 wherein the alkylene oxide is propylene oxide.

16. A method as set forth in claim 3 wherein the alkylene oxide includes a first alkylene oxide which is ethylene oxide and a second alkylene oxide which is propylene oxide.

17. A method as set forth in claim 16 wherein the ethylene oxide is present in the alkylene oxide in an amount of from about 42 to about 72 percent by weight and the propylene oxide is present in the alkylene oxide in an amount of from about 28 to about 58 percent by weight, based on 100 parts by weight of the alkylene oxide.

18. A method as set forth in claim 3 wherein the polymer has a molecular weight of from about 500 to about 10,000.

19. A method as set forth in claim 18 wherein the polymer has a molecular weight of from about 4,000 to about 9,500.

20. A method as set forth in claim 3 wherein the step of adding the polymer to the aqueous system comprises adding the polymer to an aqueous component of the aqueous system in an amount of from about 0.8 ppm to about 350 ppm of the aqueous component.

21. A method as set forth in claim 3 wherein the aqueous component of the aqueous system, initially saturated with the silica and/or silicate compounds, retains at least 210 ppm of the silica and/or silicate compounds dissolved in the aqueous component 22 hours after the addition of from about 20 to about 30 ppm of the polymer to the aqueous component.

22. A method as set forth in claim 3 wherein the aqueous component of the aqueous system, initially saturated with the silica and/or silicate compounds, retains at least 230 ppm of the silica and/or silicate compounds dissolved in the aqueous component 22 hours after the addition of from about 20 to about 30 ppm of the polymer to the aqueous component.

23. A method of inhibiting the deposition of silica and/or silicate compounds on a surface in an aqueous system, said method comprising the step of adding the polymer to the aqueous system, the polymer comprising:
A. a core comprising a fatty acid or an ester thereof;
B. a plurality of polymeric side chains bonded to the polymeric core, the plurality of polymeric side chains comprising alkyleneoxy groups selected from the group of ethyleneoxy groups, propyleneoxy groups, butyleneoxy groups, and combinations thereof, the side chains terminating with a hydrogen atom.

24. A method as set forth in claim 23 wherein the alkyleneoxy groups are the ethyleneoxy groups and the propyleneoxy groups.

25. A method as set forth in claim 24 wherein the ethyleneoxy groups and the propyleneoxy groups are present in the polymer in a molar ratio of from about 2.5:1 to about 1:2.

26. A method as set forth in claim 23 wherein the alkyleneoxy groups of the plurality of polymeric side chains are arranged randomly.

27. A method as set forth in claim 23 wherein the plurality of polymeric side chains are linear.

28. A method as set forth in claim 23 wherein the polymer has a molecular weight of from about 500 to about 10,000.

29. A method as set forth in claim 28 wherein the polymer has a molecular weight of from about 4,000 to about 9,500.

30. A method as set forth in claim 23 wherein the step of adding the polymer to the aqueous system comprises adding the polymer to an aqueous component of the aqueous system in an amount of from about 0.8 ppm to about 350 ppm of the aqueous component.

31. A method as set forth in claim 23 wherein an aqueous component, initially saturated with the silica and/or silicate compounds, retains at least 210 ppm of the silica and/or silicate compounds dissolved in the aqueous component 22 hours after the addition of the polymer in an amount of from about 20 to about 30 ppm to the aqueous component.

32. A method as set forth in claim 23 wherein an aqueous component, initially saturated with the silica and/or silicate compounds, retains at least 230 ppm of the silica and/or silicate compounds dissolved in the aqueous component 22 hours after the addition of the polymer in an amount of from about 20 to about 30 ppm to the aqueous component.

33. A method of inhibiting the deposition of silica and/or silicate compounds on a surface in an aqueous system, said method comprising the step of adding the polymer to the aqueous system, the polymer having the following formula:
Aₓ[(B_{y})H]_{z}
wherein
A is a fatty acid or an ester thereof, and
x is at least 1;
B is an alkyleneoxy group selected from the group of ethyleneoxy groups, propyleneoxy groups, butyleneoxy groups, and combinations thereof,
and y is at least 1, and
z is at least 1; and
H is a hydrogen atom.
